(19) United States
(12) Patent Application Publication
(10) Pub. No.: US 2018/0195013 A1
(43) Pub. Date: Jul. 12, 2018

(54) METHOD FOR CONVERTING HEAVY HYDROCARBON FEEDSTOCKS

(71) Applicant: IFP ENERGIES NOUVELLES, Rueil-Malmaison (FR)

(72) Inventors: Matthieu DREILLARD, Lyon (FR); Frederic FEUGNET, Lyon (FR); Joao MARQUES, Chasse sur Rhone (FR); Frederic MOREL, Chatou (FR)

(73) Assignee: IFP Energies nouvelles, Rueil-Malmaison (FR)

(21) Appl. No.: 15/558,846

(22) PCT Filed: Feb. 16, 2016
(86) PCT No.: PCT/EP2016/053255

§ 371 Date: Sep. 15, 2017

(30) Foreign Application Priority Data
Mar. 16, 2015 (FR) 1552092

(51) Int. Cl. C10G 65/12; C10G 47/04; C10G 47/12; B01J 23/28; B01J 23/755; B01J 21/04

(52) U.S. Cl. CPC C10G 65/12; C10G 47/04; C10G 47/12; B01J 23/28; C10G 2300/4018; B01J 21/04; C10G 2300/107; C10G 2300/1074; C10G 2300/1077; B01J 23/755

(57) ABSTRACT

The invention concerns a process for the conversion of a heavy hydrocarbon feed, said process comprising the following steps: a) a step for hydroconversion of the heavy hydrocarbon feed in the presence of hydrogen in at least one or more three-phase reactors disposed in series or in parallel, containing at least one hydroconversion catalyst, so as to obtain a liquid effluent with a reduced Conradson carbon, metals, sulphur and nitrogen content, b) one or more optional steps for separating the effluent obtained from step a) in order to obtain at least one light liquid fraction boiling at a temperature of less than 350° C. and a heavy liquid fraction boiling at a temperature of more than 350° C., c) a step for hydroconversion of the liquid effluent obtained from the hydroconversion step a) in the case in which the separation step b) is not carried out, or of the heavy liquid fraction obtained from the separation step b) when said step b) is carried out, in the presence of hydrogen in at least one or more three-phase reactors disposed in series or in parallel and containing at least one hydroconversion catalyst, in which process the overall hourly space velocity employed is in the range 0.05 to 0.18 h⁻¹.

### TECHNICAL FIELD OF THE INVENTION

The present invention relates to a process for the conversion of a heavy hydrocarbon feed advantageously obtained either from a crude oil or from atmospheric and/or vacuum distillation of a crude oil and containing at least 80% by weight of a fraction with an initial boiling temperature of at least 300° C.

### PRIOR ART

More precisely, the feeds which are treated in the context of the present invention are either crude oils or heavy hydrocarbon fractions obtained from the atmospheric distillation and/or vacuum distillation of a crude oil and containing at least 80% by weight of a fraction with an initial boiling temperature of at least 300° C., preferably at least 350° C. and more preferably at least 375° C., and preferably vacuum residues containing at least 80% by weight of a fraction with an initial boiling temperature of at least 450° C. and preferably at least 500° C. These feeds are generally hydrocarbon fractions with a sulphur content of at least 0.1% by weight, preferably at least 1% by weight and more preferably at least 2% by weight, a Conradson carbon of at least 3% by weight, and preferably at least 5% by weight, an asphaltenes content C₇ of at least 0.1% by weight and preferably at least 3% by weight and a metals content of at least 20 ppm and preferably at least 100 ppm.

These oil residues are relatively difficult to upgrade. In fact, the market overwhelmingly demands fuels which can be distilled at atmospheric pressure at a temperature of less than 320° C. or even 380° C. The crude oils are characterized by variable contents of atmospheric residues which depend on the origin of the crudes which are treated. This content generally varies between 20% and 50% for conventional crudes, but may reach 50% to 80% for heavy crudes and extra-heavy crudes such as, for example, those produced in Venezuela or in the Athabasca region in the north of Canada. Thus, it is necessary to convert these residues by transforming the heavy molecules of the residues in order to produce refined products constituted by lighter molecules. These refined products generally have a hydrogen to carbon ratio which is higher than the initial heavy cuts. A range of processes used to produce refined light cuts, such as hydrocracking, hydrotreatment and hydroconversion processes, is thus based on adding hydrogen to the molecules, preferably at the same time as cracking these heavy molecules.

The conversion of heavy cuts depends on a large number of parameters such as the composition of the feed, the technology of the reactor used, the severity of the operating conditions (temperature, pressure, partial pressure of hydrogen, dwell time, etc), the type of catalyst used and its activity. By increasing the severity of the operation, the conversion of heavy cuts into light products is increased, but significant quantities of by-products such as coke precursors and sediments start to be formed via secondary reactions. The intense conversion of heavy feeds thus very often results in a formation of solid particles (known as sediments), which are very viscous and/or sticky and are composed of asphaltenes, coke and/or fine particles of catalyst. The excessive presence of these products then results in deactivation of the catalyst, and leads to clogging of the equipment of the process, and in particular in the separation and distillation equipment. For this reason, the refiner is obliged to reduce the conversion of the heavy cuts in order to avoid stopping the hydroconversion unit.

The formation of these sediments in hydroconversion processes is highly dependent on the quality of the feed and the severity of the operation. In fact, asphaltenes present in the feed are principally converted by dealkylation under severe hydroconversion conditions, and for this reason form highly condensed aromatic rings which render the effluents unstable and which precipitate in the form of sediments.

### Aim and Advantage of the Invention

One of the aims of the invention is to provide a process layout for a hydroconversion process which can be used to improve the stability of the effluents for a given level of conversion of the heavy cuts, and also to increase the conversion compared with conventional hydroconversion processes.

Conventional process layouts for the hydroconversion of residues such as those described in U.S. Pat. No. 4,521,295, U.S. Pat. No. 4,495,060 or U.S. Pat. No. 4,457,831 recommend operating at hourly space velocities (HSV) or space velocities (volume flow rate of feed with respect to the reaction volume) in the range 0.1 to 2.5 h⁻¹, temperatures in the range 300-500° C. and partial pressures of hydrogen in the range 1000 to 5000 psig. In these process layouts, the temperature remains the key parameter for controlling the level of conversion of the heavy cuts. For a high conversion operation, a high temperature is thus recommended in order to increase thermal cracking of the heavy cuts. In this configuration, the maximum level of conversion allowing appropriate operation of an industrial unit will always be limited by the formation of sediments. In fact, the temperature increases the condensation/polymerization reaction kinetics more rapidly than that for hydrogenation reactions, thus bringing about secondary and unwanted reactions which are responsible for the formation of sediments and coke precursors.

In order to overcome this limit of operability of the hydroconversion units, conventional process layouts for the conversion of residues in the prior art can incorporate supplemental steps such as deasphalting in order to obtain high levels of conversion for a reduced severity. This is the case with the concept described in patents US 2008/0083652, U.S. Pat. No. 7,214,308 and U.S. Pat. No. 5,980,730. In fact, in residue hydroconversion process layouts combining a deasphalting unit with a fixed bed, moving bed, ebullated bed and/or entrained slurry bed hydroconversion unit, the deasphalting unit may be positioned upstream via an indirect route such as, for example, in patent U.S. Pat. No. 7,214,308, or downstream of the hydroconversion process via a direct route such as, for example, in patents FR 2 776 297 and U.S. Pat. No. 5,980,730. The patents FR 2 776 297, U.S. Pat. No. 5,980,730 and U.S. Pat. No. 7,214,308 describe these two possible types of conversion process layout in detail.

A process layout for the hydroconversion of residues generally associates two principal unitary steps in succession: a hydroconversion step and a deasphalting step, with an intermediate atmospheric distillation step and optionally an intermediate vacuum distillation step being carried out between these two unitary steps. In general, recycles of deasphalted oil (DAO) to the hydroconversion step may be employed in this type of process layout.

The greatest limitations to this type of process layout are the quantity of asphalt produced, which is difficult to upgrade; recycling the DAO cut to the inlet to the hydroconversion zone, which demands a substantial increase in the volume of the reaction zones as well as the separation zones (as described in patents US 2012/061292A and WO 14096591A1) increases the investment required and the operating costs compared with a process without DAO recycling.

Fluxes such as aromatic cuts, non-exhaustive examples of which that may be cited including LCO (light cycle oil), HCO (heavy cycle oil) obtained from the fluid catalytic cracking process, may be used in order to stabilize the effluents from residue hydroconversion units. However, their use has a major impact on the yield of the process because the cost of these cuts and their use results in an increase in the size of the units. In addition, these stabilizing cuts are not always available on site and their use is necessarily to the detriment of the production of an upgradeable cut. This set of reasons explains why the use of a stabilizing cut is very limited.

The present invention proposes simultaneously improving the level of conversion and the stability of liquid effluents by means of a process layout for the conversion of heavy feeds with a thermal level and a dwell time for the feed which are optimized. The process in accordance with the invention can be used to obtain a conversion of the feed which is higher than that obtained by a configuration termed a conventional configuration for a comparable stability of the liquid effluents. In addition, the present invention can also be used to produce effluents with an identical level of conversion to a conventional prior art process, but with better stability of the liquid effluents produced.

### SUMMARY OF THE INVENTION

The present invention concerns a process for the conversion of a heavy hydrocarbon feed, comprising the following steps:

a) a step for hydroconversion of the heavy hydrocarbon feed in the presence of hydrogen in at least one or more three-phase reactors disposed in series or in parallel, containing at least one hydroconversion catalyst, the hydroconversion step a) being carried out under an absolute pressure in the range 2 to 35 MPa, a temperature in the range 300° C. to 550° C., and under a quantity of hydrogen mixed with the feed in the range 50 to 5000 normal cubic metres (Nm³) per cubic metre (m³) of feed, in a manner such as to obtain a liquid effluent with a reduced Conradson carbon, metals, sulphur and nitrogen content,
b) one or more optional steps for separating the effluent obtained from step a) in order to obtain at least one light liquid fraction boiling at a temperature of less than 350° C. and a heavy liquid fraction boiling at a temperature of more than 350° C.,
c) a step for hydroconversion of the liquid effluent obtained from the hydroconversion step a) in the case in which the separation step b) is not carried out, or of the heavy liquid fraction obtained from the separation step b) when said step b) is carried out, in the presence of hydrogen in at least one or more three-phase reactors disposed in series or in parallel, containing at least one hydroconversion catalyst, the hydroconversion step c) being carried out under an absolute pressure in the range 2 to 38 MPa, at a temperature in the range 300° C. to 550° C., and under a quantity of hydrogen in the range 50 to 5000 normal cubic metres (Nm³) per cubic metre (m³) of liquid feed under standard temperature and pressure conditions,
in which process the overall hourly space velocity employed is in the range 0.05 to 0.18 h⁻¹.

In the present invention, the term “overall space velocity” means the space velocity employed throughout the process layout, i.e. taking all of the reactors used in the process in steps a) and c) into account.

In one embodiment, the process in accordance with the invention may include a plurality of hydroconversion steps, preferably at least two hydroconversion steps, and a plurality of optional separation steps between the hydroconversion steps.

### DETAILED DESCRIPTION OF THE INVENTION

### The Feed

The feed treated in the process in accordance with the invention is a heavy hydrocarbon feed (termed a residue). Advantageously, this feed is a feed comprising hydrocarbon fractions produced in the refinery. The feeds in accordance with the invention include feeds containing hydrocarbon fractions at least 80% by weight of which having a boiling temperature of more than 300° C., atmospheric residues and/or vacuum residues, atmospheric residues and/or vacuum residues obtained from hydrotreatment, hydrocracking and/or hydroconversion, fresh or refined vacuum distillates, cuts from a cracking unit such as FCC, coking or visbreaking, aromatic cuts extracted from a lubricant production unit, deasphalted oils obtained from a deasphalting unit, asphalts obtained from a deasphalting unit or similar hydrocarbon feeds, or a combination of these fresh feeds and/or refined effluents. Said feed may also contain a residual fraction obtained from the direct liquefaction of coal (an atmospheric residue and/or vacuum residue obtained, for example, from the H-Coal™ process), a vacuum distillate obtained from the direct liquefaction of coal such as, for example, the H-Coal™ process, coal pyrolysis residues or shale oil residues, or in fact a residual fraction obtained from the direct liquefaction of lignocellulosic biomass alone or as a mixture with coal and/or a fresh and/or refined oil fraction.

Preferably, the feed treated in the context of the present invention is constituted by hydrocarbon fractions obtained from a crude oil or from atmospheric distillation of a crude oil or from vacuum distillation of a crude oil, said feeds containing at least 80% by weight of a fraction with an initial boiling temperature of at least 300° C., preferably at least 350° C. and more preferably at least 375° C., and even more preferably vacuum residues with a boiling temperature of at least 450° C., preferably at least 500° C. and more preferably at least 540° C.

All of these feeds cited above contain impurities such as metals, sulphur, nitrogen, Conradson carbon and heptane insolubles, also known as C₇ asphaltenes. These types of feeds are in fact generally rich in impurities, with metals contents of more than 20 ppm, preferably more than 100 ppm. The sulphur content is more than 0.1%, preferably more than 1%, and preferably more than 2% by weight. The quantity of C₇ asphaltenes is as high as a minimum of 0.1% by weight and is preferably more than 3% by weight. C₇ asphaltenes are compounds which are known to inhibit the conversion of residual cuts, both because of their ability to form heavy hydrocarbon residues, generally known as coke, and because of their tendency to produce sediments which significantly limit the operability of the hydrotreatment and hydroconversion units. The Conradson carbon content is more than 3%, and preferably at least 5% by weight. The Conradson carbon content is defined by ASTM standard D 482 and represents to the person skilled in the art a well-known evaluation of the quantity of carbon residues produced after a pyrolysis under standard temperature and pressure conditions.

### Hydroconversion Step a)

In accordance with the invention, said heavy hydrocarbon feed is treated in a hydroconversion step a) comprising at least one or more three-phase reactors disposed in series or in parallel. These hydroconversion reactors may, inter alia, be reactors of the fixed bed, moving bed, ebullated bed and/or entrained slurry bed type, depending on the feed to be treated. Preferably, an ebullated bed type reactor is used. In this step, said feed is transformed under specific hydroconversion conditions. Step a) is carried out under an absolute pressure in the range 2 to 35 MPa, preferably in the range 5 to 25 MPa and more preferably in the range 6 to 20 MPa, at a temperature in the range 300° C. to 550° C., preferably in the range 350° C. to 500° C. and more preferably in the range 370° C. to 430° C., and yet more preferably in the range 380° C. to 430° C. The quantity of hydrogen mixed with the feed is preferably in the range 50 to 5000 normal cubic metres (Nm³) per cubic metre (m³) of liquid feed under standard temperature and pressure conditions, preferably in the range 100 to 2000 Nm³/m³ and highly preferably in the range 200 to 1000 Nm³/m³.

This first hydroconversion step is advantageously carried out in one or more three-phase hydroconversion reactors, which may be in series and/or in parallel, advantageously using ebullated bed reactor technology. This step is advantageously carried out using the technology and conditions of the H-Oil™ process such as that described, for example, in patents U.S. Pat. No. 4,521,295 or U.S. Pat. No. 4,495,060 or U.S. Pat. No. 4,457,831 or in the article by Aiche, Mar. 19-23, 1995, Houston, Tex., paper number 46d, “Second generation ebullated bed technology”. In this implementation, each reactor is operated as a three-phase fluidized bed, also termed an ebullated bed. In one of the implementations for reactors operating in fluidized bed mode, each reactor advantageously comprises a recirculating pump in order to maintain the catalyst as an ebullated bed by continuously recycling at least a portion of a liquid fraction which is advantageously withdrawn from the head of the reactor and re-injected into the bottom of the reactor.

The hydroconversion catalyst used in the hydroconversion step a) of the process of the invention contains one or more elements from groups 4 to 12 of the periodic table of the elements, which may or may not be deposited on a support. Advantageously, it is possible to use a catalyst comprising a support, preferably amorphous, such as silica, alumina, silica-alumina, titanium dioxide or combinations of these structures, and highly preferably alumina, and at least one metal from group VIII selected from nickel and cobalt, preferably nickel, said element from group VIII preferably being used in association with at least one metal from group VIE selected from molybdenum and tungsten; preferably, the metal from group VIB is molybdenum. Advantageously in accordance with the invention, the hydroconversion catalyst of step a) is a catalyst comprising an alumina support and at least one metal from group VIII selected from nickel and cobalt, preferably nickel, said element from group VIII being used in association with at least one metal from group VIB selected from molybdenum and tungsten; preferably, the metal from group VIB is molybdenum. Preferably, the hydroconversion catalyst comprises nickel as the element from group VIII and molybdenum as the element from group VIB. The quantity of nickel is advantageously in the range 0.5% to 10%, expressed as the weight of nickel oxide (NiO) and preferably in the range 1% to 6% by weight, and the molybdenum content is advantageously in the range 1% to 30%, expressed as the weight of molybdenum trioxide (MoO₃), and preferably in the range 4% to 20% by weight. This catalyst is advantageously used in the form of extrudates or beads.

A “slurry” type catalyst or entrained catalyst may be used in the process in accordance with the invention. Said slurry catalyst has a granulometry and density which is suitable for it to be entrained. The term “entraining” of the dispersed catalyst means that it is caused to move in the three-phase reactor or reactors by liquid streams, said second catalyst moving from the bottom towards the top, with the feed, in said three-phase reactor(s), and being withdrawn from said three-phase reactor or reactors with the liquid effluent produced.

In one embodiment of the process in accordance with the invention, each reactor of the hydroconversion step a) may use a different catalyst adapted to the feed which is sent to that reactor. In one of the embodiments of the process in accordance with the invention, several types of catalyst may be used in each reactor. In one preferred embodiment, each reactor of step a) and/or step c) may contain one or more supported catalysts and/or one or more unsupported catalysts.

In accordance with the process of the invention, a portion of the spent hydroconversion catalyst may be replaced by fresh catalyst by withdrawing, preferably from the bottom of the reactor, and by introducing, either to the top or to the bottom of the reactor, fresh catalyst and/or spent catalyst and/or regenerated catalyst and/or rejuvenated catalyst, preferably at regular time intervals and preferably in bursts or quasi-continuously. The catalyst may be replaced by replacing all or part of the spent catalyst and/or regenerated catalyst and/or rejuvenated catalyst obtained from the one reactor and/or from another reactor from any hydroconversion step. The catalyst may be added with the metals in the form of metal oxides, with metals in the form of metal sulphides, or after pre-conditioning. For each reactor, the ratio of replacement of the spent hydroconversion catalyst by fresh catalyst is advantageously in the range 0.01 kilogram to 10 kilograms per cubic metre of treated feed, and preferably in the range 0.1 kilogram to 3 kilograms per cubic metre of treated feed. This withdrawal and replacement are carried out with the aid of devices which can advantageously allow this hydroconversion step to be operated continuously.

It is also possible to send the spent catalyst withdrawn from the reactor to a regeneration zone in which the carbon and sulphur it contains is eliminated, then to return the regenerated catalyst to the hydroconversion step. It is also possible to send the spent catalyst withdrawn from the reactor to a rejuvenation zone in which the major proportion of the deposited metals are eliminated before sending the spent and rejuvenated catalyst to a regeneration zone in which the carbon and sulphur it contains is eliminated, then returning this regenerated catalyst to the hydroconversion step.

### b) Optional Separation Step

The effluent obtained from the hydroconversion step a) may then undergo one or more separation steps. In accordance with the invention, this separation remains optional; the effluent from the hydroconversion step a) may be sent directly to the hydroconversion step c).

In the case in which said separation step is carried out, at least a portion of the effluent obtained from the hydroconversion step a) is sent to said separation step.

This separation step is carried out with the aim of advantageously obtaining at least one liquid fraction termed the light fraction boiling mainly at a temperature of less than 350° C. and at least one liquid fraction termed the heavy fraction boiling mainly at a temperature of more than 350° C.

At least a portion of the light liquid fraction may then be sent to a fractionation section where the light gases (H₂ and C₁-C₄) are advantageously separated out in order to obtain the light liquid fraction boiling mainly at a temperature of less than 350° C., using any separation means known to the person skilled in the art such as, for example, by passage through a flash drum in order to recover gaseous hydrogen which may advantageously be recycled to the inlet to the hydroconversion step a). Said light liquid fraction, advantageously separated from said light gases and boiling mainly at a temperature of less than 350° C., contains the dissolved light gases, a fraction boiling at a temperature of less than 150° C. corresponding to naphthas, a fraction boiling between 150° C. and 250° C., corresponding to the kerosene fraction and at least a portion of the gas oil fraction boiling between 250° C. and 375° C. Said light liquid fraction separated from step b) is advantageously sent to the fractionation step d).

The heavy liquid fraction from the separation step b) boiling mainly at a temperature of more than 350° C. may optionally contain a portion of the gas oil fraction boiling between 250° C. and 375° C., but it contains at least one fraction boiling between 375° C. and 540° C., termed the vacuum distillate, and a fraction boiling at a temperature of more than 540° C., termed the unconverted vacuum residue. At least a portion of this heavy liquid fraction is then sent to the hydroconversion step c), in the case in which the separation step is carried out.

The separation step may be carried out using any separation means known to the person skilled in the art. Preferably, the separation step b) is carried out using one or more flash drums in series, and preferably by a single flash drum. Preferably, this flash drum is operated at a pressure and a temperature close to the operating conditions of the last reactor of the hydroconversion step a).

In another embodiment, the separation step is carried out by a concatenation of a plurality of flash drums, operating under operating conditions which are different from those of the last reactor of the hydroconversion step a) in order to obtain a plurality of light liquid fractions, at least a portion of which will then be sent to a fractionation section, while at least a portion of the heavy liquid fraction is then sent to the hydroconversion step c) of the invention.

In another embodiment, the separation step is carried out by one or more steam and/or hydrogen stripping columns. By this means, the effluent obtained from the hydroconversion step a) will be separated into a light liquid fraction and a heavy liquid fraction at least a portion of which will then be sent to the hydroconversion step c) of the invention.

In another embodiment, the separation step is carried out by an atmospheric distillation column separating the effluent obtained from the hydroconversion step a). At least a portion of the heavy liquid fraction recovered from the bottom of the atmospheric distillation column may then be sent to the hydroconversion step c) of the invention.

In another embodiment, the separation step is carried out by an atmospheric distillation column separating the effluent obtained from the first hydroconversion step, followed by a vacuum distillation column acting on the residue from the atmospheric distillation column. At least a portion of the heavy liquid fraction recovered from the bottom of the vacuum distillation column may then be sent to the hydroconversion step c) of the invention.

The separation step may also be constituted by a combination of these different embodiments as described above, in an order which differs from that described above.

Optionally, before being sent to the hydroconversion step c) of the invention, the heavy liquid fraction may undergo a step for steam and/or hydrogen stripping with the aid of one or more stripping columns. This step can be used to eliminate at least a portion of the vacuum distillate (hydrocarbons with a boiling temperature of less than 540° C.) contained in the heavy liquid fraction.

### Hydroconversion Step c)

In accordance with the invention, the liquid effluent obtained from the hydroconversion step a) in the case in which the separation step b) is not carried out, or the heavy liquid fraction obtained from the separation step b) when it is carried out, is treated in the hydroconversion step c).

This hydroconversion step c) is composed of one or more three-phase reactors which may be in series and/or in parallel. These hydroconversion reactors may, inter alia, be reactors of the fixed bed, moving bed, ebullated bed and/or entrained slurry bed type, depending on the feed to be treated, in particular the effluent obtained from the hydroconversion step a) or the heavy liquid fraction obtained from the separation step b). Preferably, an ebullated bed type reactor is used. In this step, the feed to be treated is generally transformed under conventional conditions for the hydroconversion of a liquid hydrocarbon fraction. Usually, the operation is carried out under an absolute pressure in the range 2 to 35 MPa, preferably in the range 5 to 25 MPa and more preferably in the range 6 to 20 MPa, at a temperature in the range 300° C. to 550° C., preferably in the range 350° C. to 500° C. and more preferably in the range 370° C. to 430° C. The quantity of hydrogen mixed with the feed to be treated is preferably in the range 50 to 5000 normal cubic metres (Nm³) per cubic metre (m³) of liquid feed under standard temperature and pressure conditions, and preferably in the range 100 to 2000 Nm³/m³ and highly preferably in the range 200 to 1000 Nm³/m³.

This hydroconversion step c) is advantageously carried out in one or more three-phase hydroconversion reactors, which may be in series and/or in parallel, using ebullated bed reactor technology. This step is advantageously carried out using the technology and conditions of the H-Oil™ process such as that described, for example, in patents U.S. Pat. No. 4,521,295 or U.S. Pat. No. 4,495,060 or U.S. Pat. No. 4,457,831 or in the article by Aiche, Mar. 19-23, 1995, Houston, Tex., paper number 46d, “Second generation ebullated bed technology”. In this implementation, each reactor is operated as a three-phase fluidized bed, also termed an ebullated bed. In one of the implementations for reactors operating in fluidized bed mode, each reactor advantageously comprises a recirculating pump in order to maintain the catalyst as an ebullated bed by continuously recycling at least a portion of a liquid fraction which is advantageously withdrawn from the head of the reactor and re-injected into the bottom of the reactor.

The hydroconversion catalyst used in the hydroconversion step c) of the process of the invention contains one or more elements from groups 4 to 12 of the periodic table of the elements, which may or may not be deposited on a support. Advantageously in accordance with the invention, the hydroconversion catalyst of step c) is a catalyst comprising an alumina support and at least one metal from group VIII selected from nickel and cobalt, preferably nickel, said element from group VIII preferably being used in association with at least one metal from group VIB selected from molybdenum and tungsten; preferably, the metal from group VIB is molybdenum. The quantity of nickel in the hydroconversion catalyst is advantageously in the range 0.5% to 10%, expressed as the weight of nickel oxide (NiO), and preferably in the range 1% to 6% by weight, and the molybdenum content is advantageously in the range 1% to 30%, expressed as the weight of molybdenum trioxide (MoO₃), and preferably in the range 4% to 20% by weight. This catalyst is advantageously used in the form of extrudates or beads. The catalyst used in the hydroconversion step c) is identical to or different from that used in the hydroconversion step a). Advantageously, the catalyst used in the reactor or reactors of the hydroconversion step c) may also be a catalyst that is more suitable for the hydroconversion of residual cuts obtained from the hydroconversion step a).

A “slurry” type catalyst or entrained catalyst may be used in the process in accordance with the invention. Said slurry catalyst has a granulometry and density which is suitable for it to be entrained. The term “entraining” of the dispersed catalyst means that it is caused to move in the three-phase reactor or reactors by liquid streams, said second catalyst moving from the bottom towards the top, with the feed, in said three-phase reactor(s), and being withdrawn from said three-phase reactor or reactors with the liquid effluent produced.

In one embodiment of the process in accordance with the invention, each reactor of the hydroconversion step c) may use a different catalyst adapted to the feed which is sent to that reactor. In one of the embodiments of the process in accordance with the invention, several types of catalyst may be used in each reactor. In one preferred embodiment, each reactor of step a) and/or step c) may contain one or more supported catalysts and/or one or more unsupported catalysts.

For each reactor, the ratio for replacement of the spent hydroconversion catalyst by fresh catalyst is advantageously in the range 0.01 kilogram to 10 kilograms per cubic metre of treated feed, and preferably in the range 0.1 kilogram to 3 kilograms per cubic metre of treated feed. This withdrawal and replacement are carried out with the aid of devices which can advantageously permit the continuous operation of this hydroconversion step.

In accordance with the invention, the hourly space velocity (HSV) with respect to the volume and flow rate of the liquid feed for the process as a whole under standard temperature and pressure conditions is in the range 0.05 h⁻¹ to 0.18 h⁻¹, preferably in the range 0.05 h⁻¹ to 0.09 h⁻¹ and more preferably in the range 0.05 h⁻¹ to 0.08 h⁻¹.

These conditions for the process of the invention can be used to simultaneously improve the degree of conversion and the stability of the liquid effluents by a process layout for the conversion of heavy feeds with an optimized temperature and dwell time for the feed.

### Fractionation Step d)

At least a portion of the effluent obtained from the hydroconversion step c) may advantageously then undergo a fractionation step d). This separation encompasses any fractionation means known to the person skilled in the art. This fractionation is carried out using one or more flash drums in series, preferably a concatenation of at least two successive flash drums, more preferably one or more steam stripping and/or hydrogen stripping columns, yet more preferably an atmospheric distillation column, and even more preferably using an atmospheric distillation column and a vacuum column on the atmospheric residue, yet more preferably one or more flash drums, an atmospheric distillation column and a vacuum column on the atmospheric residue. This fractionation may also be carried out by a combination of the various separation means described above.

The fractionation step is carried out with the aim of separating the effluents at different cut points and advantageously obtaining at least one heavy liquid fraction termed an unconverted vacuum residue boiling mainly at a temperature of more than 300° C., preferably more than 500° C. and yet more preferably more than 540° C.

### DESCRIPTION OF THE FIGURES

FIG. 1 diagrammatically represents the process in accordance with the invention in the case in which the separation step b) is carried out.

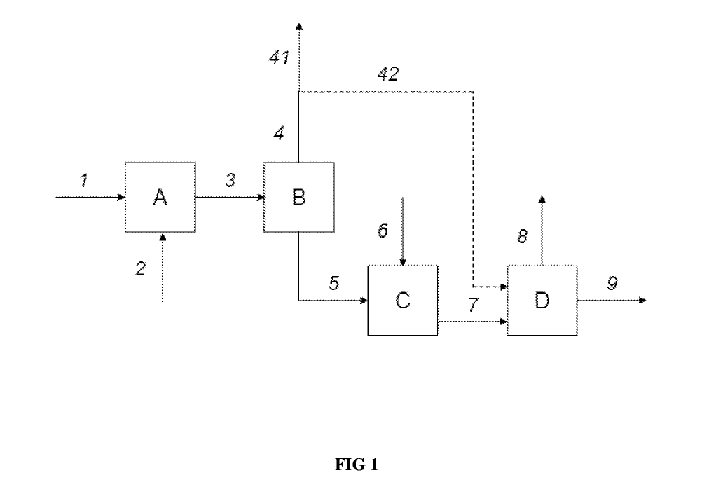

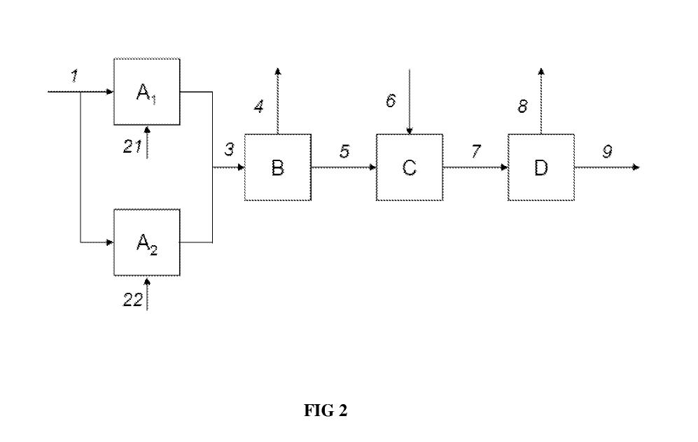

The feed is sent via the line 1 to a hydroconversion section A operating at a high hydrogen pressure and preferably in ebullated bed mode.

(A) represents the step a) for hydroconversion of the feed 1 in the presence of hydrogen, with the hydrogen arriving via the conduit 2. The hydroconversion step a) may be composed of one or more reactors disposed in parallel and/or in series.

The effluent from the hydroconversion section A is sent to the separation section B via the conduit 3.

The heavy liquid fraction obtained from the separation section B is sent to the hydroconversion step c) represented by the section C via the conduit 5, while the light effluent is extracted from the separation B via the conduit 4. Part or all of this latter may be sent to the fractionation section D via the conduit 42 and/or partially and/or completely directed towards another unitary operation via the conduit 41.

The hydroconversion step c), C, is composed of one or more reactors disposed in parallel and/or in series. The conduit 6 represents the injection of hydrogen into the hydroconversion step c). The entirety of the effluent from the hydroconversion step c), C, may be sent to the fractionation section D via the conduit 7 for fractionation into a plurality of cuts. In this process layout, only two cuts are shown, a light cut 8 and a heavy cut 9.

FIG. 2 illustrates the invention in a preferred embodiment.

The feed is sent via the conduit 1 to the hydroconversion step a) (section A) which is composed of a plurality of reactors disposed in series and/or in parallel and preferably composed of two reactors operating in ebullated bed mode (A₁ and A₂) disposed in parallel and operating under hydrogen (conduits 21 and 22 respectively).

The effluents obtained from the hydroconversion section A are combined and sent via the conduit 3 to the separation section B. In the separation section B, the conditions are generally selected in a manner such as to obtain two liquid fractions, a fraction termed a light fraction 4 and a fraction termed a heavy fraction 5, using any separation means known to the person skilled in the art, preferably without intermediate atmospheric distillation and vacuum columns, preferably by stripping, more preferably by a concatenation of flash drums and yet more preferably via a single flash drum.

The heavy liquid fraction leaving the separation section is then sent via the conduit 5 to the hydroconversion section C composed of one or more reactors disposed in parallel and/or in series and preferably composed of a single reactor with a high hydrogen pressure 6 operating in ebullated bed mode.

In the fractionation section D, the conditions are generally selected in a manner such as to obtain at least two liquid fractions, a fraction termed a light fraction 8, and a fraction termed a heavy fraction 9, preferably with the aid of a series of atmospheric and vacuum distillation columns.

The following examples illustrate the invention without limiting its scope.

### EXAMPLES

### Feed

The heavy feed was a vacuum residue (VR) from an Oural crude the principal characteristics of which are presented in Table 1 below.

TABLE 1
Composition of feed for the process

| Feed for step | | A |
|---|---|---|
| Feed | | VR Oural |
| Density | | 1.0165 |
| Viscosity at100° C. | cSt | 880 |
| Conradson Carbon | % by wt | 17.0 |
| C7 Asphaltenes | % by wt | 5.5 |
| C5 Asphaltenes | % by wt | 10.9 |
| Nickel + Vanadium | ppm | 254 |
| Nitrogen | ppm | 6150 |
| Sulphur | % by wt | 2.715 |

This heavy VR feed was used as the fresh feed for all of the various examples.

### Example 1 (Comparative)

Conventional process layout at high hourly space velocity (overall HSV=0.3 h⁻¹) and at high temperature

This example illustrates the prior art in a process layout with two ebullated bed reactors disposed in series, operated at high hourly space velocity (HSV) and at a high temperature and with a separation section.

### Section a) Hydroconversion

The fresh feed of Table 1 was sent in its entirety to a section A for hydroconversion in the presence of hydrogen. Said section comprised a three-phase reactor containing a NiMo/alumina hydroconversion catalyst with a NiO content of 4% by weight and a MoO₃ content of 9% by weight, the percentages being expressed with respect to the total mass of catalyst. The section functioned in ebullated bed mode with an upflow of liquid and gas.

The conditions applied in the hydroconversion section A are shown in Table 2.

TABLE 2
Operating conditions

| Section | | A |
|---|---|---|
| P, total | MPa | 16 |
| Temperature | ° C. | 430 |
| Quantity of hydrogen | Nm³/m³ | 640 |

These operating conditions allowed a liquid effluent with a reduced Conradson carbon, metals and sulphur content to be obtained.

### Separation Section

The hydroconverted liquid effluent was then sent to a separation section B composed of a single gas/liquid separator operating at the pressure and temperature of the reactors of the first hydroconversion section A. A fraction termed a light fraction and a fraction termed the heavy fraction were then separated. The light fraction was mainly composed of molecules with a boiling point of below 350° C. and the fraction termed the heavy fraction was mainly composed of molecules of hydrocarbons boiling at a temperature of more than 350° C.

### Section c) for Hydroconversion

The characterization of the heavy fraction sent to the second hydroconversion section C is presented in Table 3.

TABLE 3
Composition of the feed for section b) for hydroconversion in
ebullated bed mode, C

| Feed for step | | C |
|---|---|---|
| Feed | | Heavy |
| | | fraction |
| Density | | 0.9742 |
| Conradson carbon | % by wt | 11.9 |
| C₇ Asphaltenes | % by wt | 5.2 |
| C₅ Asphaltenes | % by wt | 5.2 |
| Nickel + Vanadium | ppm | 104.4 |
| Nitrogen | ppm | 5890 |
| Sulphur | % by wt | 1.2601 |

In this reference process layout, the heavy fraction 5 was sent alone and in its entirety to a second hydroconversion section C in the presence of hydrogen, 6. Said section comprised a three-phase reactor containing a NiMo/alumina hydroconversion catalyst with a NiO content of 4% by weight and a MoO₃ content of 9% by weight, the percentages being expressed with respect to the total mass of catalyst. The section functioned in ebullated bed mode with an upflow of liquid and of gas.

The conditions applied to the hydroconversion section C are presented in Table 4.

TABLE 4
Operating conditions

| Section | | C |
|---|---|---|
| P, total | MPa | 15.6 |
| Temperature | ° C. | 430 |
| Quantity of hydrogen | Nm³/m³ | 420 |

### Fractionation Section

The effluent from the hydroconversion section C was sent to a fractionation section D composed of an atmospheric distillation from which a light fraction 8 boiling at a temperature essentially below 350° C. and an unconverted heavy atmospheric residue fraction AR boiling at a temperature essentially higher than 350° C. were recovered; the yields with respect to the fresh feed and the quality are given in Table 5 below.

TABLE 5
Yields and Qualities of effluents from the fractionation section

| | | Unconverted |
|---|---|---|
| | | atmospheric |
| Fraction | | residue |
| Yield with respect to | % by wt | 58.4 |
| fresh feed (1) | | |
| Density | | 0.9678 |
| Conradson carbon | % by wt | 9.55 |
| C₇ Asphaltenes | % by wt | 4.0 |
| Nickel + Vanadium | ppm | 41.5 |
| Nitrogen | ppm | 5885 |
| Sulphur | % by wt | 0.7849 |
| Sediments (IP-375) | % by wt | 0.54 |

### Overall Performances

With this conventional process layout, for an overall hourly space velocity (HSV) of 0.3 h⁻¹, the total conversion of the heavy 540° C.+ cut was 75.4% by weight and the sediments content (IP-375) in the unconverted residual heavy cut AR was 0.54% by wt.

### Example 2 (in Accordance with the Invention)

Process layout in accordance with the invention with low hourly space velocity (overall HSV=0.089 h⁻¹) and low temperature

In this example, the present invention is illustrated in a process layout with two ebullated bed reactors disposed in series, operated at a low hourly space velocity (HSV) and at a low temperature and with a separation section.

### Hydroconversion Section a)

The fresh feed of Table 1 was sent in its entirety to a section A for hydroconversion in the presence of hydrogen, said section comprising a three-phase reactor containing a NiMo/alumina hydroconversion catalyst with a NiO content of 4% by weight and a MoO₃ content of 9% by weight, the percentages being expressed with respect to the total mass of catalyst. The section functioned in ebullated bed mode with an upflow of liquid and gas.

The conditions applied in the hydroconversion section A are shown in Table 6.

TABLE 6
Operating conditions

| Section | | A |
|---|---|---|
| P, total | MPa | 16 |
| Temperature | ° C. | 410 |
| Quantity of hydrogen | Nm³/m³ | 1000 |

These operating conditions allowed a liquid effluent with a reduced Conradson carbon, metals and sulphur content to be obtained.

### Separation Section

The hydroconverted liquid effluent was then sent to an interposed separation section B composed of a single gas/liquid separator operating at the pressure and temperature of the reactors of the first hydroconversion section. A fraction termed a light fraction and a fraction termed the heavy fraction were then separated. The light fraction was mainly composed of molecules with a boiling point of below 350° C. and the fraction termed the heavy fraction was mainly composed of molecules of hydrocarbons boiling at a temperature of more than 350° C.

### Section c) for Hydroconversion

The characterization of the heavy fraction sent to the second hydroconversion section C is presented in Table 7.

TABLE 7
Composition of the feed for the ebullated bed hydroconversion
section (C)

| Feed for step | | C |
|---|---|---|
| Feed | | Heavy fraction |
| Density | | 0.9665 |
| Conradson carbon | % by wt | 10.57 |
| C₇ Asphaltenes | % by wt | 3.6 |
| C₅ Asphaltenes | % by wt | 4.2 |
| Nickel + Vanadium | ppm | 65.7 |
| Nitrogen | ppm | 5680 |
| Sulphur | % by wt | 1.030 |

In this process layout in accordance with the present invention, the heavy fraction 5 was sent alone and in its entirety to a second hydroconversion section C in the presence of hydrogen, 6, said section comprising a three-phase reactor containing a NiMo/alumina hydroconversion catalyst with a NiO content of 4% by weight and a MoO₃ content of 9% by weight, the percentages being expressed with respect to the total mass of catalyst. The section functioned in ebullated bed mode with an upflow of liquid and of gas.

The conditions applied to the hydroconversion section C are presented in Table 8.

TABLE 8
Operating conditions

| Section | | C |
|---|---|---|
| P, total | MPa | 15.6 |
| Temperature | ° C. | 410 |
| Quantity of hydrogen | Nm³/m³ | 560 |

### Fractionation Section

The effluent from the hydroconversion section C was sent to a fractionation section D composed of an atmospheric distillation from which a light fraction 8 boiling at a temperature essentially below 350° C. and an unconverted heavy atmospheric residue fraction AR boiling at a temperature essentially higher than 350° C. were recovered; the yields with respect to the fresh feed and the quality are given in Table 9 below.

TABLE 9
Yields and Qualities of effluents from the fractionation section

| | | Unconverted |
|---|---|---|
| | | atmospheric |
| Fraction | | residue |
| Yield with respect to | % by wt | 54.0 |
| fresh feed (1) | | |
| Density | | 0.9590 |
| Conradson carbon | % by wt | 7.42 |
| C₇ Asphaltenes | % by wt | 2.1 |
| Nickel + Vanadium | ppm | 10.3 |
| Nitrogen | ppm | 5305 |
| Sulphur | % by wt | 0.4684 |
| Sediments (IP-375) | % by wt | 0.15 |

### Overall Performance

With this process layout in accordance with the invention with an overall HSV=0.089 h⁻¹, the total conversion of the heavy 540° C.+ cut was 75.3% by weight and the sediments content (IP-375) in the unconverted heavy residual AR cut was only 0.15% by weight. Compared with the conventional process layout dealt with in Example 1, the purification performance was higher for an almost identical level of conversion of the heavy 540° C.+ cut. The stability of the liquid effluents from conversion was very substantially improved.

1. A process for the conversion of a heavy hydrocarbon feed, said process comprising the following steps:
a) a step for hydroconversion of the heavy hydrocarbon feed in the presence of hydrogen in at least one or more three-phase reactors disposed in series or in parallel, containing at least one hydroconversion catalyst, the hydroconversion step a) being carried out under an absolute pressure in the range 2 to 35 MPa, a temperature in the range 300° C. to 550° C., and under a quantity of hydrogen mixed with the feed in the range 50 to 5000 normal cubic metres (Nm³) per cubic metre (m³) of feed, in a manner such as to obtain a liquid effluent with a reduced Conradson carbon, metals, sulphur and nitrogen content,
b) one or more optional steps for separating the effluent obtained from step a) in order to obtain at least one light liquid fraction boiling at a temperature of less than 350° C. and a heavy liquid fraction boiling at a temperature of more than 350° C.,
c) a step for hydroconversion of the liquid effluent obtained from the hydroconversion step a) in the case in which the separation step b) is not carried out, or of the heavy liquid fraction obtained from the separation step b) when said step b) is carried out, in the presence of hydrogen in at least one or more three-phase reactors disposed in series or in parallel, containing at least one hydroconversion catalyst, the hydroconversion step c) being carried out under an absolute pressure in the range 2 to 38 MPa, at a temperature in the range 300° C. to 550° C., and under a quantity of hydrogen in the range 50 to 5000 normal cubic metres (Nm³) per cubic metre (m³) of liquid feed under standard temperature and pressure conditions,
in which process the overall hourly space velocity employed is in the range 0.05 to 0.18 h⁻¹.

2. The process as claimed in claim 1, in which the overall hourly space velocity employed is in the range 0.05 h⁻¹ to 0.09 h⁻¹.

3. The process as claimed in claim 1, in which at least a portion of the effluent obtained from the hydroconversion step c) undergoes one or more steps d) for fractionation in order to separate the effluents with different cut points.

4. The process as claimed in claim 1, in which the feed contains hydrocarbon fractions wherein at least 80% by weight have a boiling temperature of more than 300° C., atmospheric residues and/or vacuum residues, atmospheric residues and/or vacuum residues obtained from hydrotreatment, hydrocracking and/or hydroconversion, fresh or refined vacuum distillates, cuts from a cracking unit such as FCC, coking or visbreaking, aromatic cuts extracted from a lubricant production unit, deasphalted oils obtained from a deasphalting unit, asphalts obtained from a deasphalting unit or similar hydrocarbon feeds, or a combination of these fresh feeds and/or refined effluents, or residues or distillates obtained from the direct liquefaction of coal, or residues or distillates obtained from coal pyrolysis or from shale oils, or in fact a residual fraction obtained from the direct liquefaction of lignocellulosic biomass alone or as a mixture with coal and/or a fresh and/or refined oil fraction.

5. The process as claimed in claim 1, in which step a) or step c) is carried out at an absolute pressure in the range 5 to 25 MPa, at a temperature in the range 350° C. to 500° C.

6. The process as claimed in claim 1, in which each reactor in step a) and/or step c) may contain one or more supported catalysts and/or one or more unsupported catalysts.

7. The process as claimed in claim 1, in which the hydroconversion catalyst of step a) or step c) is a catalyst comprising an alumina support and at least one metal from group VIII selected from nickel and cobalt, said element from group VIII being used in association with at least one metal from group VIB selected from molybdenum and tungsten.

8. The process as claimed in claim 1, in which the quantity of nickel in the hydroconversion catalyst of step a) is in the range 0.5% to 10%, expressed as the weight of nickel oxide (NiO), and the molybdenum content is in the range 1% to 30%, expressed as the weight of molybdenum trioxide (MoO₃).

9. The process as claimed in claim 1, in which the separation step b) is carried out using one or more flash drums in series.

10. The process as claimed in claim 3, in which the light liquid fraction separated in step b) is sent to the fractionation step d).
